(19) United States
(12) Patent Application Publication
(10) Pub. No.: US 2025/0111351 A1
(43) Pub. Date: Apr. 3, 2025

(54) ACCOUNT MANAGEMENT FOR LIMITED USERS

(71) Applicant: PAYPAL, INC., San Jose, CA (US)

(72) Inventors: Andrea Nicole Lown, Toronto (CA); Jason Young, Toronto (CA)

(21) Appl. No.: 18/374,960

(22) Filed: Sep. 29, 2023

(51) Int. Cl. G06Q 20/32; G06Q 20/42

(52) U.S. Cl. CPC G06Q 20/3223; G06Q 20/3276; G06Q 20/42

(57) ABSTRACT

A method according to the present disclosure may include receiving information associated with a user; generating, via a computing device, a limited account for the user, the limited account having at least one restriction, according to the received information; causing a code associated with the limited account to be applied to a physical token; providing, to a mobile device that scans the code, limited access to the limited account; receiving, from the mobile device, an instruction to transfer an asset to or from the limited account; and causing the asset to be transferred according to the instruction.

### TECHNICAL FIELD

The instant disclosure relates to providing account management capabilities for users with limited access.

### BACKGROUND

The ability to function within the economy of a developed country is largely dependent on access to banks and bank accounts, as basic transacting generally requires the exchange or swap of bank account data, such as debit card numbers or routing numbers. As part of this dependence, fewer individuals carry hard currency (e.g., bills, coins), which further isolates those who rely on such hard currency in avoidance of (or due to lack of access to) banks.

### BRIEF DESCRIPTION OF THE DRAWINGS

FIG. 1A is a block diagram of an example system for managing an account for a limited user.

FIG. 1B is a block diagram of a fob of the example system of FIG. 1A.

FIG. 2 is a sequence diagram of an example workflow of the example system of FIG. 1A.

FIG. 3 is a flow chart illustrating an example method of managing an account for a limited user.

FIG. 4 is a flow chart illustrating an example method of managing an account for a limited user.

FIG. 5 is a diagrammatic view of an example embodiment of a user computing environment.

### DETAILED DESCRIPTION

Generally, participation in a modern-day economy requires a bank account. A bank account is increasingly necessary as society rapidly adopts digital forms of money, which offer greater security, convenience and flexibility. This trend was accelerated by the global Coronavirus pandemic, in which a large number of businesses moved to online commerce and moved away from accepting cash at point of sale. These trends have had the trickle-down effect of reducing the number of individuals who carry cash on their person regularly. As a result, people with limited access to bank accounts (or bank account-like services, such as app-based financial managers)—who would otherwise transact entirely with cash—are increasingly marginalized. This includes small businesses and charities without the infrastructure to support credit cards (e.g., youth organizations, street fundraisers, farmer's market booths, craftspeople, children's lemonade stands etc.), as well as unhoused or otherwise disadvantaged persons who rely on spontaneous charity, often in the form of cash donations to make ends meet. This may also include “closed-loop” economies in which users participate in the economy with a currency unique to that economy, such as on a cruise-ship or at an arcade, where fiat currency may be infeasible or undesired.

Accordingly, there exists a need for a system that allows such account-limited individuals to participate in the modern-day cashless economy without establishing a fully-enabled bank account. As described herein, such a system may facilitate the creation by a third party of a limited account for the limited individual that may include some (but not all) of the features generally associated with bank accounts. This limited account may enable the limited individual to receive cashless payments or donations that the limited individual may convert to (e.g., withdraw as) cash with assistance (and oversight) from the original third party. In addition, this limited account may accommodate those users without some or all of the requirements traditionally associated with full bank accounts, including a mailing address, phone number, multiple forms of identification, etc.

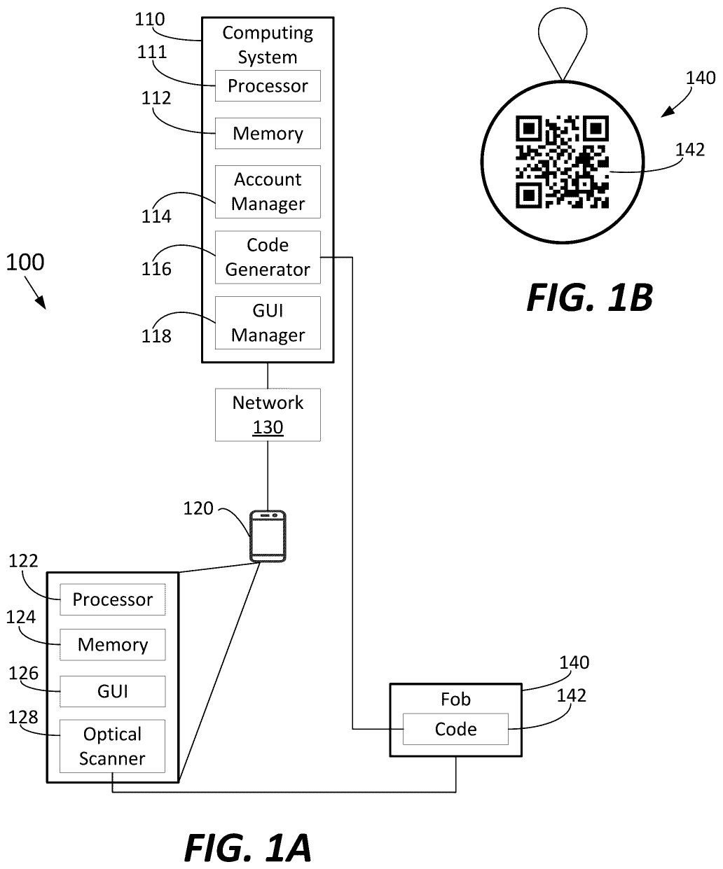

Referring to the drawings, wherein like reference numerals refer to the same or similar features in the various views, FIG. 1A is a block diagram of an example system 100 for managing an account for a limited user. The system 100 may include a computing system 110 and a user device 120, which may be in electronic communication with one another and/or with other components via a network 130. The network 130 may include any suitable connection (or combinations of connections) for transmitting data to and from each of the components of the system, and may include one or more communication protocols that dictate and control the exchange of data. The system 100 may further include a fob 140, which is shown in greater detail in FIG. 1B.

As shown, the computing system 110 may include one or more functional modules 114, 116, and 118 embodied in hardware and/or software. In an embodiment, the functional modules 114, 116, and 118 of the computing system 110 may be embodied in a processor 111 and a memory 112 (i.e., a non-transitory, computer-readable medium) storing instructions that, when executed by the processor 111, cause the computing system 110 to perform the functionality of one or more of the functional modules 114, 116, and 118 and/or other functionality of this disclosure. For example, the computing system 110 may open an account for a limited user and may provide the user device 120 access to the account over the network 130.

Each of the user devices 120 may include a processor 122 and a memory 124, which may be any suitable processor and memory. In particular, the user devices 120 may be mobile devices (e.g., smartphones, tablets, laptops, etc.). The memory 124 may store instructions that, when executed by the processor 122, cause a graphical user interface (GUI) 126 to display on the user device 120. This GUI 126 may be provided, in part, by the computing system 110 and, particularly, one of the functional modules of the computing system 110 (e.g., GUI manager 118). The GUI 126 may enable access to the limited account, and may facilitate one or more interactions with the limited account, such as viewing a balance, making a deposit, or redeeming the balance for cash and/or credit. The user devices 120 may further include an optical scanner 128 that may be any suitable device for capturing a visual element for processing. For example, the optical scanner 128 may be a camera, bar-code scanner, or other suitable device. The optical scanner 128 may be configured to scan a code (e.g., code 142) associated with a limited account and to transmit data associated with the scanned code to the processor 122 for processing.

The functional modules 114, 116, and 118 of the computing system 110 may include an account manager 114 configured to receive information regarding a limited user, and to establish an account for the limited user. The account manager 114 may establish the account as a limited account, such that the account includes one or more restrictions and/or lacks one or more features relative to a fully-enabled account. For example, the limited account may not be connected to a debit card (e.g., the limited user may not directly transact using funds in the limited account), and the limited account may have limits on withdrawal and/or use in particular transactions. In another example, the limited account may be limited to conducting transactions (e.g., withdrawals, deposits, transfers) within a physical location (e.g., a geographical-based limitation) or with a subset of devices (e.g., an IP-based limitation), or may be limited to transactions below a threshold value (e.g., a cap on withdrawals) or with a particular account (e.g., may only transact with an account associated with a parent). For example, a limited account may be opened for a child selling baked goods as a fundraiser, and the limited account may be associated with an account for the child's parent. Any payment for the baked goods may be initially deposited into the limited account, but may then be automatically (e.g., after a set period of time) transferred into the associated parent's account.

In some embodiments, the account manager 114 may open a normal account and convert the account to a limited account by disabling certain features. In some embodiments, the account manager 114 may open an entirely-limited account (e.g., closed for any use) and convert the account to a limited account by enabling certain features. An account opened by the account manager 114 may be hosted by the computing system 110.

The functional modules 114, 116, and 118 of the computing system 110 may include a code generator 116 configured to generate a visual code 142 associated with the limited account created by the account manager 114. The visual code 142 may be or may include any combination of characters (e.g., letters, numbers, symbols) that, when entered into a corresponding application, may provide access into the limited account. The visual code 142 may be or may include a bar code (e.g., QR code) that, when scanned or processed by a device's camera (e.g., optical scanner 128), may provide the device access (e.g., viewing capability, transaction capability, etc.) to the limited account. As described in greater depth below, the amount of access may be dynamically determined based on the device 120 scanning the code 142. Accordingly, the code generator 116 may embed, in the visual code 142, a uniform resource locator (URL) or link to the account, as well as data naming or identifying the limited account. The code generator 116, in addition to generating the code 142, may cause the code 142 to be printed on the fob 140 by, for example, issuing commands to a connected printer. In some embodiments, the fob 140 may include a short-range transponder (e.g., radio-frequency identifier) for interacting with the device 120, such that the fob 140 may be “tapped” or otherwise physically interacted with in order to provide the link to the limited account.

In some embodiments, a URL respective of a limited account or link to a limited account may be or may include a URL of or link to a website through which the account may be accessed. Additionally or alternatively, a link to the limited account may include a command to launch a particular electronic user interface (e.g., application) through which the limited account may be accessed.

In some embodiments, the fob 140 may be configured for passive near-field communication (NFC), such that the fob 140 may generate its NFC signal when exposed to a changing magnetic field provided by an active NFC device (e.g., credit card reader, door reader, etc.). This active NFC device may then receive and process the generated NFC signal. In these embodiments, the fob 140 may be used in place of a bank card (e.g., credit card, debit card, gift card, etc.) at a checkout, such that a holder of the fob 140 may ‘tap’ or otherwise introduce the fob 140 to the card reader and have the fob 140 complete the transaction. As an example, a holder of the fob 140 may receive a spontaneous donation from another individual, and then may use the fob 140 at a grocery store to pay for goods with the spontaneous donation. In this way, the fob 140 may enable the user—who may be unable to open a bank account—to access funds in a stored account.

The code generator 116 may also generate the code 142 to provide different amounts of information or levels of access to different devices based on an authority of the device. For example, the code generator 116 may embed additional levels of data that, when interacted with by a particular device (e.g., the computer used to initially set up the limited account, a device specifically designated as a master device, etc.), may provide master-level access to the limited account, while other devices that scan the same code 142 may only be able to deposit in the limited account. This may improve security for the limited account, as it further limits account activity (e.g., withdrawal) to a single (or select) location.

The functional modules 114, 116, and 118 of the computing system 110 may include a GUI manager 118 configured to provide an interactive interface (e.g., GUI 126) on the user device 120 to facilitate the user device's 120 interactions with the limited account. In particular, the GUI manager 118 may generate the content displayed on the user device 120 in response to the user device 120 entering or scanning the code 142 from the code generator 116. In particular, the user device 120 may scan a code 142 (e.g., via the optical scanner 128), may derive information from the code 142 (e.g., via the processor 122), and may communicate with the computing system 110 based on the derived information. The content generated by the GUI manager 118 may include a prompt for confirmation or an indication of next steps. Accordingly, the GUI manager 118 may determine content for the GUI 126 based on a response from the user device 120 to the generated content. As discussed above, the code 142 may provide different levels of access based on the authority of the user device 120, so the initial message from the user device 120 after scanning the code 142 may indicate the appropriate level of access (e.g., via a passcode embedded in the code 142, a unique identifier derived from the code 142, etc.). The GUI manager 118 may also facilitate the actual interaction between the user device 120 and the limited account. In one example in which the limited account is associated with an unbanked person soliciting spontaneous donations, the GUI manager 118 may provide the interface for selecting a donation amount, entering payment details, and initiating the transfer.

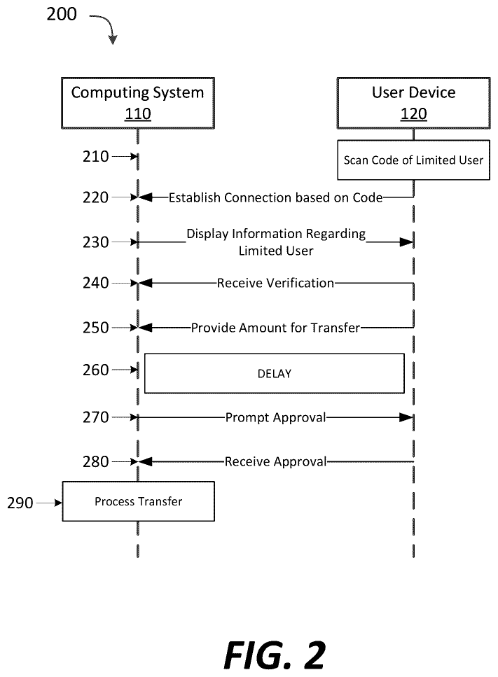

FIG. 2 is a sequence diagram illustrating an example workflow 200 of the system 100 of FIG. 1A. As shown, the workflow 200 involves the computing system 110 and the user device 120, and may begin with the user device 120 scanning (or otherwise receiving) a code (e.g., code 142) at operation 210. The code 142 may be printed onto a card or fob (e.g., fob 140), which may be carried by a limited user and presented as necessary. In one example in which the limited user is a farmer's market booth proprietor, the user may extend the fob at “checkout” for a purchaser to scan and submit payment. The code 142 may also be sent to a device for display on a screen of the device, such that the user may present their code by showing the code as an image on their device.

At operation 220, the user device 120 may establish a connection with the computing system 110 (e.g., over the network 130) based on the code 142. As discussed above, the connection may be based on a determined authority level of the user device 120 based on data stored or embedded in the scanned code 142, and may utilize information (e.g., links) stored in the code 142.

At operation 230, the computing system 110 (and particularly the GUI manager 118) may generate information and interactive elements for display on the user device 120. The content of the generated information and interactive elements may be based on data embedded or otherwise stored in (and extracted from) the code 142 and subsequently transmitted to the computing system 110 by the user device 120 in response to the user device 120 scanning the code 142, as well as based on the user device 120 (e.g., permissions associated with the user device 120, a location of the user device 120, etc.). For example, the location of the user device 120 at the time that the user device 120 scans the code 142 may determine the level of access granted to the user device 120 by the computing system 110. The user device 120 location may be included with the transmission to the computing system 110 of extracted data from the code 142. The computing system 110 may determine that the location of the user device 120 matches a location stored in the code 142 and associated with a level of higher access, and may, in response, grant the higher level of access to the user device 120.

The information displayed may include a photograph or other piece of identifying information regarding the limited user that may be relied upon by a user of the user device 120 to confirm that the limited account is, in fact, associated with the limited user that provided the code 142. The information may be accompanied by an interactive element requesting confirmation that the displayed information matches that of the limited user that provided the code 142.

A user may select or otherwise interact with the interactive element to take an action with respect to the limited account. For example, the user may use the interactive element to cause or otherwise facilitate (e.g., to cause the devices 120 to cause or otherwise facilitate) a transfer or deposit into the limited account, or the interactive element may facilitate viewing a balance of the limited account. In some embodiments, the computing system 110 may generate such action-associated interactive elements only after receiving verification from the user device 120 regarding the displayed information.

At operation 240, the user device 120 may send, to the computing system 110, verification regarding the displayed information. The verification may be initiated by a user's interaction with an interactive element displayed in concert with the personal information of the limited user. For example, the computing system 110 (e.g., at operation 230) may display a photograph of the limited user with an interactive element prompting a user to confirm that the displayed photograph is of the same individual that presented the code 142 for scanning, or the computing system 110 may display a photograph associated with (but not explicitly of) the limited user, such as a logo of the limited user's business or an image that has meaning for the limited user and would be expected by only the limited user (e.g., the limited user's favorite sports team, favorite animal, etc.). In another example, the computing system 110 may display a knowledge-based question (e.g., What-You-Know verification) particular to the limited user.

At operation 250, the user device 120 may send, to the computing system 110, an amount to be transferred from an account associated with the user device 120 (e.g., with a user of the user device 120) to the limited account. The account associated with the user device 120 may be stored on the user device 120, or may be entered by a user as part of the prompt for an amount to transfer. The amount may be entered on the user device 120 via an interactive element generated on the GUI 126 by the computing system 110. As discussed above, such an interactive element (e.g., associated with an action to be taken) may be presented in response to the verification at operation 240, such that a user device 120 may not send an amount to be transferred until the user device 120 has confirmed that the limited account is the intended account.

At operation 260, the computing system 110 may introduce a delay following the user device 120 before, at operation 270, presenting a prompt for the user device 120 to confirm the transfer, which may be received at operation 280. The delay may be configured to ensure that the user device 120 selected to initiate the transfer and did not do so under duress or a similarly-motivating event. By prompting the user device 120 to confirm the transfer after the delay, the computing system 110 may reduce or entirely eliminate the risk of users transferring under pressure. The delay may be any suitable length of time to allow the user of the user device 120 to distance themselves from the limited user, and may range from 30 seconds to 10 minutes. In some embodiments, the computing system 110 may not introduce a delay at all, such that the workflow 200 proceeds directly to operation 290 from operation 250.

At operation 290, the computing system 110 processes the transfer according to the amount given by the user device 120 at operation 250.

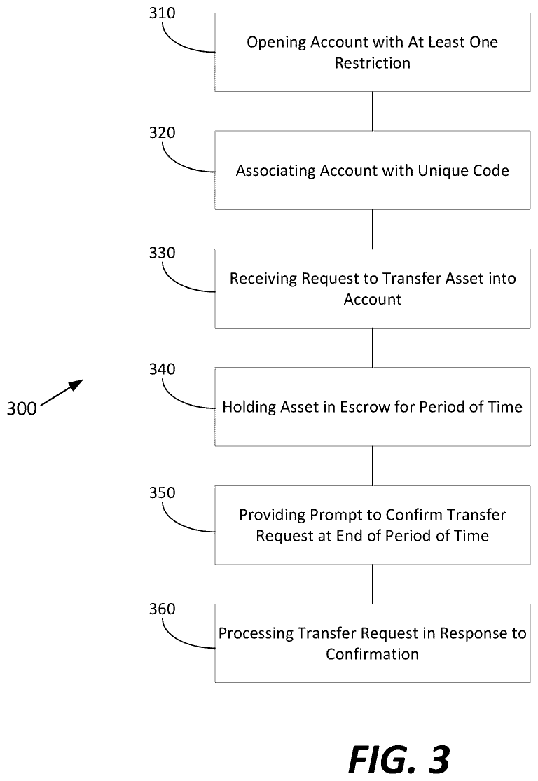

FIG. 3 is a flow chart illustrating an example method 300 of managing an account for a limited user. The method 300, or one or more portions of the method 300, may be performed by system 100 and particularly the computing system 110 (shown in FIG. 1A), in some embodiments.

The method 300 may include, at block 310, opening an account with at least one restriction in response to a request from a limited user and/or the receipt of information from the limited user. As described above, at least one restriction may comprise a limit on an ability or function of a standard (e.g., unlimited) account, such as a limit on withdrawal, limit on deposit sources, limit on spending, etc. The limited account may be structured as an unlimited account with some activities disabled, or the limited account may be structured as a completely-limited account with some activities enabled.

The method 300 may include, at block 320, associating the account with a unique code 142. As discussed above with reference to the code generator 116, the associated code may include embedded data regarding characteristics of the limited account, as well as an indication of a level of authority required to access various features of the limited account. For example, the device (e.g., computing system 110) that generates the limited account may have additional permissions for the limited account. Accordingly, the associated code may include a marker in its embedded data indicating an identifying characteristic (e.g., serial number, internet protocol (IP) address, etc.) of the generating device. When the generating device (or other device that has been granted the additional permissions) then scans the code 142, the scanning device—by virtue of matching the characteristic associated with higher permissions—may access the additional actions enabled by the higher permissions. In some embodiments, block 320 may include generating the code 142 in response to receiving the request to open the account at block 310 and then storing the account information in association with the code 142 and/or with information embedded in the code 142. Alternatively, block 320 may include receiving the code 142 and storing the account information in association with the received code and/or with information embedded in the received code.

The method 300 may include, at block 330, receiving a request to transfer an asset into the account. The prompt to request the transfer may be presented on the scanning device in response to the code being scanned, and may be presented regardless of the permissions associated with the scanning device.

The method 300 may include, at block 340, holding the asset in escrow for a period of time. As discussed above with operation 260 of the workflow 200, the computing system 110 may introduce a delay into the asset transfer process, such that the scanning device (e.g., user device 120) may have an opportunity to review (and re-think) their transfer. During this delay, the asset may have been transferred from the transferor but not yet to the limited account, such that the asset may be held in escrow (e.g., by an escrow account managed by the computing system 110).

The method 300 may include, at block 350, providing a prompt to confirm the transfer request at an end of the period of time, and, at block 360, processing the transfer request in response to the confirmation. As described above, the introduced delay may provide an opportunity for the transferor to review and/or re-consider their transfer, and the prompt enables the transferor to approve (or rescind) the transfer. In response to approval, the asset may be moved from the escrow account to the limited account. In response to disapproval, the asset may be returned to the transferor account from the escrow account.

In some embodiments, blocks 340-360 may be omitted, such that the transfer does not include the escrow period and corresponding ability to rescind the transfer. The escrow period may be omitted or skipped in response to the transfer request satisfying one or more properties, such as having a transfer amount being below a threshold (e.g., the amount of money transferred is not worth offering reconsideration), the number of transfers between the two parties being above a threshold value (e.g., the parties have transacted previously so there is no need to review or re-consider), or the nature of the transfer (e.g., for goods and services rather than as a spontaneous donation).

In an example use case of the above method 300, a first individual may be approached by a second individual, associated with charitable organization, with a request for a spontaneous charitable donation. In response to the first individual agreeing to donate, the second individual may extend a code associated with the second individual's restricted account for the first individual to scan with their phone. The first individual's phone may then display information about the charity to which the donation is requested, and the first individual may be presented with the opportunity to confirm that the information shown matches that which the second individual originally requested. Following confirmation, the first individual may be prompted to enter an amount to donate, as well as their own account information for the account from which the funds may be transferred. Once the first individual approves the transfer, the funds may be moved from the first individual's account into an escrow. The first individual then continues walking and, after a period (e.g., 10 minutes), may be prompted to confirm the transfer. If the first individual has not changed their mind, they may confirm the transfer, and the funds may be moved from the escrow account to the second individual's limited account. If the first individual has changed their mind (e.g., no longer wishes to donate), the first individual may cancel the transfer, and the funds may be moved from the escrow account back to the first individual's account.

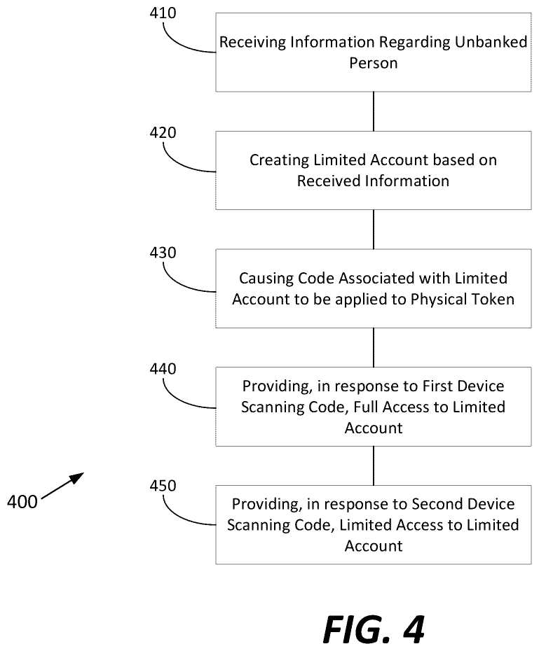

FIG. 4 is a flow chart illustrating an example method 400 of managing an account for a limited user. The method 400, or one or more portions of the method 400, may be performed by system 100 and particularly the computing system 110 (shown in FIG. 1A), in some embodiments.

The method 400 may include, at block 410, receiving information regarding a limited user. The information may include a name and photograph of the limited user that may be used to identify the limited user. Notably, the information may exclude (e.g., not include) an address, bank account, email address, or other information that may not be available to the limited user (e.g., the lack of which may designate them as a ‘limited’ user).

The method 400 may include, at block 420, creating (e.g., causing to be created) a limited account based on the received information. The limits on the limited account may be based on the received information. For example, if the received information includes an age of the limited user, a limit on the limited account may be placed in response to the limited user's age indicating that the limited user is a minor. In another example, if the received information includes that the limited account is to be used for collecting spontaneous donations, a limit that requires an escrow period may be placed on the limited account.

In those embodiments in which the fob 140 associated with the limited account is capable of directly transacting with others (e.g., via passive NFC), the limits on the limited account may include a list of acceptable (or unacceptable) merchants or types of goods. When a limited user attempts to use the fob 140 to complete a transaction involving a restricted good or merchant, the transaction may be declined based on the system 110 declining the transaction for the limited account.

The method 400 may include, at block 430, causing a code associated with the limited account to be applied to a physical token. For example, the computing system 110 may generate a code indicative of the limited account, and may transmit the code to a printer for printing onto a fob, card, or similar physical token. This token may then be carried by the limited user and presented to a third party for scanning to initiate a transfer.

The method 400 may include, at block 440, providing, in response to a first device scanning the code, full access to the limited account, and, at block 450, providing, in response to a second device scanning the code, limited access to the limited account. As discussed above with reference to the code generator 116, the code 142 may include an indication of those devices with higher (or additional) permissions, such that a scanning device that matches the indication may be granted the higher permissions. In particular, the code 142 may include a list of identifying information (e.g., IP addresses, serial numbers, names, locations, email addresses, etc.) associated with users or user devices associated with higher permissions. In this embodiment, the first device may be indicated in the code as associated with higher permissions (e.g., an IP address of the first device is on the stored list), so when the first device scans the code and the computing system matches identifying information of the first device with the indication of higher access stored in the code, the first device may be granted those higher permissions (e.g., full access).

In some embodiments, the full access provided at block 440 may include a visual representation of the limited account, which may include information about the limited account as well as available actions for the limited account. In those embodiments in which the first device was used to establish multiple limited accounts (e.g., a parent for multiple children, an aid organization for multiple unhoused persons, etc.), the visual representation may include each of these limited accounts, such that the first device is able to view, manage, and control multiple limited accounts at once. These controls may include automated alerts configured to present a notification on the first device in response to certain criteria being met, such as a certain number of accounts being below a threshold value or a certain number of limited accounts having no activity. Furthermore, these controls may enable automated oversight of one or more limited accounts in order to flag, for the account manager, unusual activity (e.g., lack of spending, overspending, spending on unacceptable items, too many deposits, etc.). As such, these controls may integrate the functionality of such limited accounts into a monitoring system for tracking the well-being and habits of any limited users.

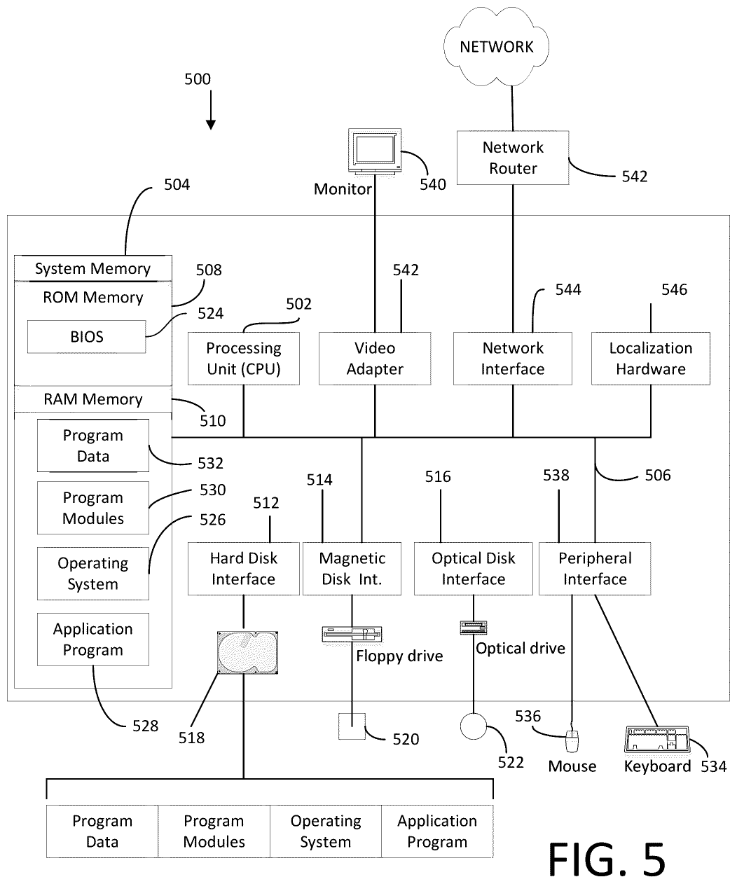

FIG. 5 is a diagrammatic view of an example embodiment of a user computing environment that includes a computing system environment 500, such as a desktop computer, laptop, smartphone, tablet, or any other such device having the ability to execute instructions, such as those stored within a non-transient, computer-readable medium. For example, the computing system environment 500 may be the user device 120 or a system hosting the computing system 110. In another example, one or more components of the computing system environment 500, such as one or more CPUs 502, RAM memory 510, network interface 544, and one or more hard disks 518 or other storage devices, such as SSD or other FLASH storage, may be included in the computing system 110. Furthermore, while described and illustrated in the context of a single computing system, those skilled in the art will also appreciate that the various tasks described hereinafter may be practiced in a distributed environment having multiple computing systems linked via a local or wide-area network in which the executable instructions may be associated with and/or executed by one or more of multiple computing systems.

In its most basic configuration, computing system environment 500 typically includes at least one processing unit 502 (e.g., processor 162) and at least one memory 504 (e.g., memory 164), which may be linked via a bus. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus, respectively, allow for reading from and writing to a hard disk 518, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard disk 518, and/or peripheral memory devices may be used to store computer executable instructions comprising an operating system 526, one or more applications programs 528 (which may include the functionality of the computing system 110 of FIG. 1A or one or more of its functional modules 114, 116, and 118, for example), other program modules 530, and/or program data 532. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 542, that is responsible for network routing. Communications with the network router 542 may be performed via a network interface component 544. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 546 for determining a location of the computing system environment 500. In embodiments, the localization hardware 546 may include, for example only, a GPS antenna, an RFID chip or reader, a WiFi antenna, or other computing hardware that may be used to capture or transmit signals that may be used to determine the location of the computing system environment 500.

In some embodiments, a computer-implemented method includes receiving information associated with a user; generating, via a computing device, a limited account for the user, the limited account having at least one restriction, according to the received information; causing a code associated with the limited account to be applied to a physical token; providing, to a mobile device that scans the code, limited access to the limited account; receiving, from the mobile device, an instruction to transfer an asset to or from the limited account; and causing the asset to be transferred according to the instruction.

In some of these embodiments, the at least one restriction includes a geographical- or internet protocol (IP) address-based limitation on withdrawal privileges.

In some of these embodiments, the geographical- or IP address-based limitation corresponds to a geographical location or IP address of a computing device from which the information associated with the user was received.

In some of these embodiments, the limited access provided to the mobile device includes deposit-only privileges.

In some of these embodiments, the method further includes causing the mobile device to display a portion of the information associated with the user.

In some of these embodiments, the information associated with the user excludes at least one of a phone number, an email address, or a mailing address.

In some of these embodiments, the method further includes, in response to receiving the instruction to transfer the asset, initiating a timer; determining that an amount of time has passed based on the timer; and in response to the determination, completing the transfer of the asset.

In some of these embodiments, the method further includes causing the mobile device to display, in response to the determination that the amount of time has passed, a prompt to confirm the transfer; and in response to the confirmation, completing the transfer.

In some embodiments, a non-transitory computer readable medium stores program instructions that, when executed by a processor, cause a computer system to perform operations including opening, for a user, an account with at least one restriction; associating the account with a unique code that, when scanned by a mobile device, provides limited access to the account; receiving, from the mobile device, a request to transfer an asset into the account in response to providing the limited access to the mobile device; holding the asset in escrow for a predetermined period of time; providing, to the mobile device at an end of the predetermined period of time, a prompt to confirm the transfer request; and receiving a confirmation from the mobile device and, in response to the confirmation, processing the transfer request.

In some of these embodiments, the at least one restriction includes a limitation on withdrawal privileges.

In some of these embodiments, the limitation on withdrawal privileges allows the user to withdraw funds at a pre-defined location.

In some of these embodiments, the limited access provided to the mobile device includes displaying an account balance and prompting a transfer into the account.

In some of these embodiments, the operations further include causing the mobile device to display, in response to the mobile device scanning the generated code, information regarding the user; causing the mobile device to display a prompt to confirm the displayed information; and causing the mobile device to display, in response to confirmation of the displayed information, an interactive element to initiate the transfer request.

In some of these embodiments, the information regarding the user includes an image of the user.

In some of these embodiments, the at least one restriction includes an internet protocol (IP) address-based limitation on withdrawal privileges.

In some embodiments, a system includes a processor; and a non-transitory computer readable medium stored thereon instructions that are executable by the processor to cause the system to perform operations including receiving, from a first computing device, information regarding a user; creating a limited account for the user based on the received information; causing a code associated with the limited account to be applied to a physical token; providing to the first computing device, in response to the first computing device scanning the code, full access to the limited account; and providing to a second computing device, in response to the second computing device scanning the code, restricted access to the limited account.

In some of these embodiments, full access includes a withdrawal privilege and a deposit privilege, and wherein restricted access includes the deposit privilege.

In some of these embodiments, the information received from the user excludes at least one of a phone number, an email address, or a mailing address.

In some of these embodiments, providing restricted access includes displaying a portion of the received information; generating a first interactive element prompting a confirmation regarding the received information; and in response to the confirmation, generating a second interactive element prompting a deposit into the limited account.

In some of these embodiments, the operations further include receiving, from the second computing device, the deposit; holding an amount of the deposit in a holding account for a period of time; at the end of the period of time, displaying, on the second computing device, a third interactive element prompting a confirmation regarding the amount of the deposit; and in response to the confirmation, executing the deposit.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A computer-implemented method comprising:
receiving information associated with a user;
generating, via a computing device, a limited account for the user, the limited account having at least one restriction, according to the received information;
causing a code associated with the limited account to be applied to a physical token;
providing, to a mobile device that scans the code, limited access to the limited account;
receiving, from the mobile device, an instruction to transfer an asset to or from the limited account; and
causing the asset to be transferred according to the instruction.

2. The method of claim 1, wherein the at least one restriction comprises a geographical- or internet protocol (IP) address-based limitation on withdrawal privileges.

3. The method of claim 2, wherein the geographical- or IP address-based limitation corresponds to a geographical location or IP address of a computing device from which the information associated with the user was received.

4. The method of claim 1, wherein the limited access provided to the mobile device comprises deposit-only privileges.

5. The method of claim 1, further comprising causing the mobile device to display a portion of the information associated with the user.

6. The method of claim 1, wherein the information associated with the user excludes at least one of a phone number, an email address, or a mailing address.

7. The method of claim 1, further comprising:
in response to receiving the instruction to transfer the asset, initiating a timer;
determining that an amount of time has passed based on the timer; and
in response to the determination, completing the transfer of the asset.

8. The method of claim 7, further comprising:
causing the mobile device to display, in response to the determination that the amount of time has passed, a prompt to confirm the transfer; and
in response to the confirmation, completing the transfer.

9. A non-transitory computer readable medium storing program instructions that, when executed by a processor, cause a computer system to perform operations comprising:
opening, for a user, an account with at least one restriction;
associating the account with a unique code that, when scanned by a mobile device, provides limited access to the account;
receiving, from the mobile device, a request to transfer an asset into the account in response to providing the limited access to the mobile device;
holding the asset in escrow for a predetermined period of time;
providing, to the mobile device at an end of the predetermined period of time, a prompt to confirm the transfer request; and
receiving a confirmation from the mobile device and, in response to the confirmation, processing the transfer request.

10. The computer readable medium of claim 9, wherein the at least one restriction comprises a limitation on withdrawal privileges.

11. The computer readable medium of claim 10, wherein the limitation on withdrawal privileges allows the user to withdraw funds at a pre-defined location.

12. The computer readable medium of claim 10, wherein the at least one restriction comprises an internet protocol (IP) address-based limitation on withdrawal privileges.

13. The computer readable medium of claim 9, wherein the limited access provided to the mobile device comprises displaying an account balance and prompting a transfer into the account.

14. The computer readable medium of claim 9, wherein the operations further comprise:
causing the mobile device to display, in response to the mobile device scanning the unique code, information regarding the user;
causing the mobile device to display a prompt to confirm the displayed information; and
causing the mobile device to display, in response to confirmation of the displayed information, an interactive element to initiate the transfer request.

15. The computer readable medium of claim 14, wherein the information regarding the user comprises an image of the user.

16. A system comprising:
a processor; and
a non-transitory computer readable medium stored thereon instructions that are executable by the processor to cause the system to perform operations comprising:
receiving, from a first computing device, information regarding a user;
creating a limited account for the user based on the received information;
causing a code associated with the limited account to be applied to a physical token;
providing to the first computing device, in response to the first computing device scanning the code, full access to the limited account; and
providing to a second computing device, in response to the second computing device scanning the code, restricted access to the limited account.

17. The system of claim 16, wherein full access comprises a withdrawal privilege and a deposit privilege, and wherein restricted access comprises the deposit privilege.

18. The system of claim 16, wherein the information received from the user excludes at least one of a phone number, an email address, or a mailing address.

19. The system of claim 16, wherein providing restricted access comprises:
displaying a portion of the received information;
generating a first interactive element prompting a confirmation regarding the received information; and
in response to the confirmation, generating a second interactive element prompting a deposit into the limited account.

20. The system of claim 19, wherein the operations further comprise:
receiving, from the second computing device, the deposit;
holding an amount of the deposit in a holding account for a period of time;
at an end of the period of time, displaying, on the second computing device, a third interactive element prompting a confirmation regarding the amount of the deposit; and
in response to the confirmation, executing the deposit.
